(19) United States
(12) Patent Application Publication
(10) Pub. No.: US 2005/0198217 A1
(43) Pub. Date: Sep. 8, 2005

(54) Apparatus and method for handling communications between subsystems of processing nodes in a telecommunication network

(75) Inventors: Nhut Nguyen, Richardson, TX (US); Hai Xiong, Plano, TX (US); Matt Wu, Plano, TX (US)

Correspondence Address: DOCKET CLERK, P.O. DRAWER 800889, DALLAS, TX, 75380, US

(73) Assignee: SAMSUNG ELECTRONICS CO., LTD., Suwon-city (KR)

(21) Appl. No.: 10/778,459

(22) Filed: Feb. 13, 2004

(51) Int. Cl. G06F 15/177; G06F 15/16

(52) U.S. Cl. 709/220; 709/250

(57) ABSTRACT

For use in a telecommunication network, a network node includes a sending entity associated with a first one of a plurality of subsystems, a receiving entity associated with a second one of the plurality of subsystems and a common interface handler in communication with the sending entity and the receiving entity. The common interface handler is operable to receive a message including identification information that is in a standard format capable of being utilized by each of the subsystems from the sending entity. The common interface handler is further operable to identify the receiving entity from the identification information and transmit the message to the receiving entity.

### TECHNICAL FIELD OF THE INVENTION

The present invention is generally related to telecommunication networks and, in particular, to a method for facilitating communications between different subsystems of processing nodes in a telecommunication network.

### BACKGROUND OF THE INVENTION

In traditional telecommunication networks, the software system within many processing nodes is made up of a number of different software subsystems, each providing a different set of functions of the network node. For example, a telecommunication switch may include several access control function subsystems, a call control function subsystem, a service control function subsystem, a resource allocation function subsystem and a subscriber database function subsystem. Each subsystem is capable of handling multiple sessions, and each session may have multiple legs. A subsystem often needs to communicate with other subsystems to realize the set of functions that it provides. However, communication between subsystems is not a trivial task, especially when information about subsystems, sessions and legs of sessions needs to be taken into account. For example, a communicating entity needs to be uniquely identified as belonging to a particular node, subsystem, session and leg.

Communication between software entities within a process or within different processes typically involves a sending entity sending a message to a receiving entity. When the two entities are within the same subsystem, message generation and transmission is a relatively simple process. However, when the two entities belong to two different subsystems, the process becomes more complex.

To effectuate communication between two software entities on different subsystems, the sending entity must possess detailed information about not only the receiving entity, but also the subsystem to which the receiving entity belongs in order to construct a message to the receiving entity. For example, such detailed information can include the subsystem name, subsystem type and address of an input handler for the entity. The subsystem type identifies the communication protocol of the subsystem, and is utilized to appropriately format the message header to ensure the message reaches the input handler for the receiving entity.

For example, a sending entity belonging to a session of a mobile access control function subsystem may need to send information pertaining to a called party to a receiving entity belonging to a session of the call control function subsystem during call processing of a mobile originated call. To transmit the information from the mobile access control function to the call control function, the sending entity at the mobile access control function subsystem obtains the detailed information pertaining to the receiving entity at the call control function subsystem, creates a message to the receiving entity in the format of the call control function subsystem and populates the necessary entity identification information in the header of the message.

When a new subsystem is added to the software system of a processing node, the existing subsystems must be updated with the detailed information associated with the new subsystem, such as the subsystem name, subsystem type and address of the input handler for the new subsystem. Likewise, when an existing subsystem is modified, the other existing subsystems must be updated with the new information associated with the modified subsystem. Each update process requires expensive and error-prone modifications to the existing software.

Therefore, there exists a need for improved systems and methods of handling communication between entities from different subsystems in processing nodes of a telecommunication network.

### SUMMARY OF THE INVENTION

The present invention discloses a technique for using a standardized (generic) message format for communication between entities of subsystems in processing nodes of telecommunication networks. In particular, the present invention provides a common interface handler to facilitate communication between entities of different subsystems. Messages are generated with identification information identifying the sending and receiving entities in a standard format and transmitted to the common interface handler for message routing. The standard format eliminates the need for each entity to maintain detailed information regarding other entities and subsystems.

To address the above-discussed deficiencies of the prior art, it is a primary object of the present invention to provide an improved processing node for use in a telecommunication network. According to an advantageous embodiment of the present invention, the network node comprises: (i) a sending entity associated with a first one of a plurality of subsystems, the sending entity being configured to generate a message including identification information in a standard format capable of being utilized by each of the plurality of subsystems; (ii) a receiving entity associated with a second one of the plurality of subsystems, the receiving entity being configured to receive the message; and (iii) a common interface handler in communication with the sending entity and the receiving entity, the common interface handler being operable to receive the message from the sending entity, determine the identity of the receiving entity from the identification information and transmit the message to the receiving entity.

According to one embodiment of the present invention, the standard format of the identification information includes an interface handler identifier identifying the interface handler responsible for handling communication between the sending entity and the receiving entity.

According to another embodiment of the present invention, the standard format of the identification information further includes a subsystem type identifier identifying a subsystem associated with the entity.

According to still another embodiment of the present invention, the standard format of the identification information further includes a session identifier identifying a session associated with the entity.

According to yet another embodiment of the present invention, the standard format of the identification information includes a context identifier identifying a leg of a session associated with the entity.

According to a further embodiment of the present invention, the common interface handler is further operable to uniquely identify the sending entity from the identification information.

According to a still further embodiment of the present invention, the common interface handler is further operable to create an entity from the identification information.

According to a yet further embodiment of the present invention, the common interface handler is further operable to generate keys that identify the sending entity and the receiving entity from the identification information.

According to an additional embodiment of the present invention, the common interface handler is further operable to receive an additional message, generate the keys from the additional message and identify the sending entity and the receiving entity using the keys.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present invention and its advantages, reference is now made to the following description taken in conjunction with the accompanying drawings, in which like reference numerals represent like parts:

FIG. 1 illustrates an exemplary telecommunication network whose processing nodes may implement a common interface handler according to the principles of the present invention;

FIG. 2 illustrates an exemplary network node in a telecommunication network implementing a common interface handler to facilitate communication between subsystems of the network node according to the principles of the present invention;

FIG. 3 illustrates a standard format for a message according to an exemplary embodiment of the present invention;

FIG. 4 illustrates a standard format for identification information within a message, according to an exemplary embodiment of the present invention;

FIG. 5 is a flow diagram illustrating the operation of the common interface handler according to one embodiment of the present invention; and

FIG. 6 is a flow diagram illustrating the operation of the common interface handler according to another embodiment of the present invention.

### DETAILED DESCRIPTION OF THE INVENTION

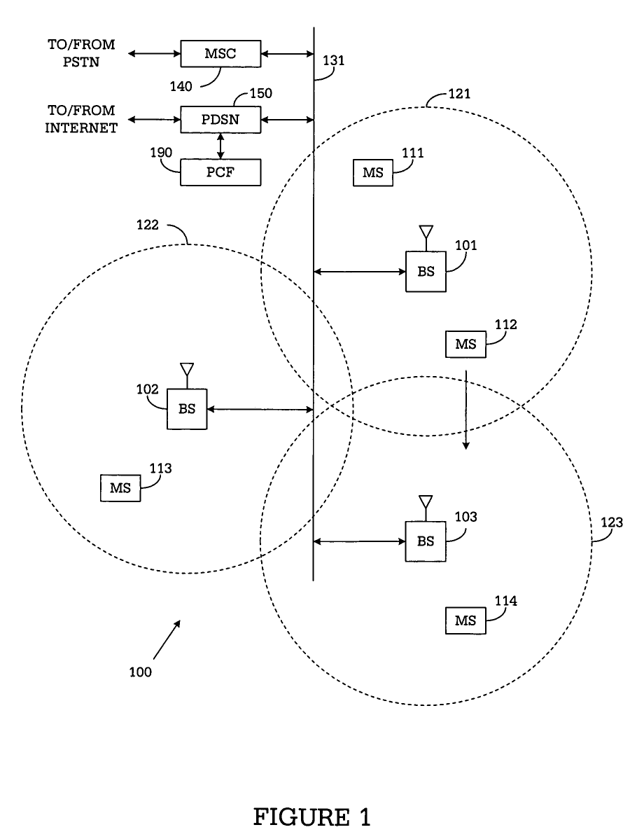

FIGS. 1 through 6, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged telecommunication network.

FIG. 1 illustrates exemplary telecommunication network 100 whose processing nodes may implement an interface handler according to the principles of the present invention. Telecommunication network 100 is a wireless network. However, it should be understood that the principles of the present invention can be applied to any telecommunication network, including, for example, public-switched networks, private networks and packet-switched networks.

Wireless network 100 comprises a plurality of cell sites 121-123, each containing one of the base stations, BS 101, BS 102, or BS 103. Base stations 101-103 communicate with a plurality of mobile stations (MS) 111-114 over code division multiple access (CDMA) channels according to, for example, the IS-2000-C standard (i.e., Release C of cdma2000). Mobile stations 111-114 may be any suitable wireless devices (e.g., conventional cell phones, PCS handsets, personal digital assistant (PDA) handsets, portable computers, telemetry devices) that are capable of communicating with base stations 101-103 via wireless links. It should be understood that the present invention is not limited to mobile devices. The present invention also encompasses other types of wireless access terminals, including fixed wireless terminals, and wireline terminals, including cordless terminals.

In one embodiment of the present invention, each of BS 101, BS 102 and BS 103 comprises a base station controller (BSC) and one or more base transceiver subsystem(s) (BTS). Base station controllers and base transceiver subsystems are well known to those skilled in the art. A base station controller is a device that manages wireless communications resources, including the base transceiver subsystems, for specified cells within a wireless communications network. A base transceiver subsystem comprises the RF transceivers, antennas, and other electrical equipment located in each cell site. This equipment may include air conditioning units, heating units, electrical supplies, telephone line interfaces and RF transmitters and RF receivers. For the purpose of simplicity and clarity in explaining the operation of the present invention, the base transceiver subsystems in each of cells 121, 122 and 123 and the base station controller associated with each base transceiver subsystem are collectively represented by BS 101, BS 102 and BS 103, respectively.

BS 101, BS 102 and BS 103 transfer voice and data signals between each other and the public switched telephone network (PSTN) (not shown) via communication line 131 and mobile switching center (MSC) 140. BS 101, BS 102 and BS 103 also transfer data signals, such as packet data, with the Internet (not shown) via communication line 131 and packet data server node (PDSN) 150. Packet control function (PCF) unit 190 controls the flow of data packets between base stations 101-103 and PDSN 150. PCF unit 190 may be implemented as part of PDSN 150, as part of MSC 140, or as a stand-alone device that communicates with PDSN 150, as shown in FIG. 1. Line 131 also provides the connection path for control signals transmitted between MSC 140 and BS 101, BS 102 and BS 103 that establish connections for voice and data circuits between MSC 140 and BS 101, BS 102 and BS 103.

Communication line 131 may be any suitable connection means, including a T1 line, a T3 line, a fiber optic link, a network packet data backbone connection, or any other type of data connection. Line 131 links each vocoder in the BSC with switch elements in MSC 140. The connections on line 131 may transmit analog voice signals or digital voice signals in pulse code modulated (PCM) format, Internet Protocol (IP) format, asynchronous transfer mode (ATM) format, or the like.

MSC 140 is a switching device that provides services and coordination between the subscribers in a wireless network and external networks, such as the PSTN or Internet. MSC 140 is well known to those skilled in the art. In some embodiments of the present invention, communications line 131 may be several different data links where each data link couples one of BS 101, BS 102, or BS 103 to MSC 140.

In the exemplary wireless network 100, MS 111 is located in cell site 121 and is in communication with BS 101. MS 113 is located in cell site 122 and is in communication with BS 102. MS 114 is located in cell site 123 and is in communication with BS 103. MS 112 is also located close to the edge of cell site 123 and is moving in the direction of cell site 123, as indicated by the direction arrow proximate MS 112.

According to the principles of the present invention, different subsystems in a processing node, such as MSC 140 and BS 101-103, of wireless network 100 are capable of communicating with each other using a standard message format and a common interface handler. The standard format eliminates the need for each entity to maintain detailed information regarding other entities and subsystems. As used herein, the term “entity” refers to an addressable logical component of software that may be a part of a single process or multiple processes.

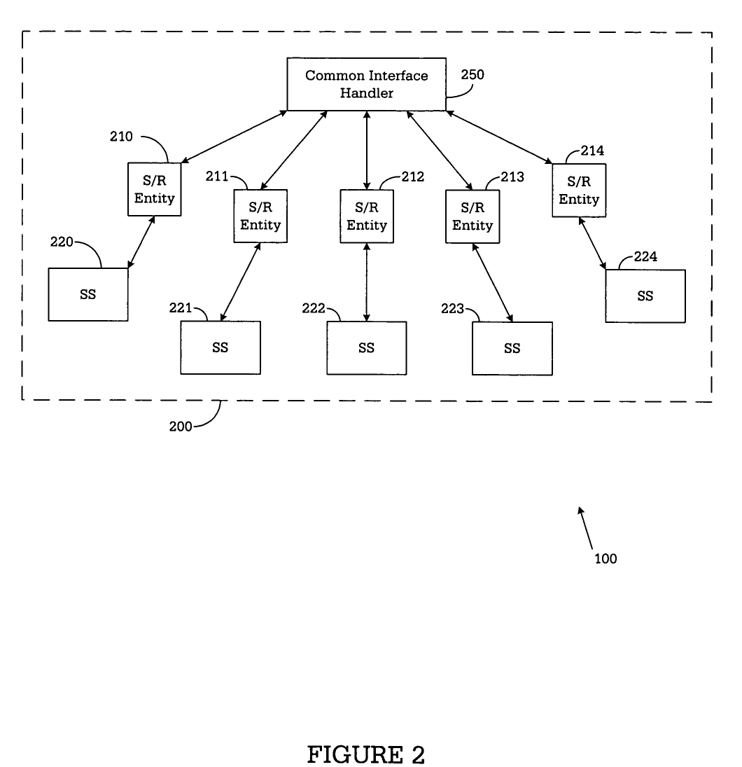

FIG. 2 illustrates an exemplary processing node 200 in telecommunication network 100 implementing a common interface handler 250 to facilitate communication between subsystems 220-224 of processing node 200 according to the principles of the present invention. For illustrative purposes, five subsystems, labeled 220, 221, 222, 223 and 224 are shown. However, it should be understood that the principles of the present invention can be applied to any number of two or more subsystems 220-224.

Each subsystem 220-224 represents a logical function of processing node 200. For example, subsystem 220 can represent an access control function that handles network access requests from subscribers, such as a mobile station requesting registration with a wireless network or sending a call setup message to originate a call, or a wireline phone going off hook or sending DTMF tones to place a call. Subsystem 221 can represent a subscriber database function accessed by the access control function to authenticate a subscriber and determine features or services subscribed to by the subscriber. Subsystem 222 can represent a resource allocation function that allocates resources, such as traffic channels and trunk lines. Subsystem 223 can represent a call control function that sets-up and tears down call connections between calling and called subscribers and provides other call-related functions. Subsystem 224 can represent a service control function that provides services to the subscriber, such as call waiting, call forwarding, conference calling, data service and other services or features subscribed to by the subscriber.

The functionality of each subsystem 220-224 is realized with software including computer-executable instructions capable of being executed on processing node 200. The computer-executable instructions include one or more processes, with each process being capable of providing functions of a single subsystem, e.g., subsystem 220, or of multiple subsystems 220-224.

Sending/receiving (S/R) entities 210-214 are associated with subsystems 220-224, respectively, to provide message sending and receiving functions for these subsystems. For illustrative purposes, five entities, labeled 210, 211, 212, 213 and 214, are shown. Entity 210 is associated with subsystem 220, entity 211 is associated with subsystem 221, entity 212 is associated with subsystem 222, entity 213 is associated with subsystem 223 and entity 214 is associated with subsystem 224.

In accordance with the principles of the present invention, entities 210-214 communicate with each other through common interface handler 250. Common interface handler 250 manages sessions between two entities, for example entities 210 and 211, from two different subsystems, for example subsystems 220 and 221. Entities 210 and 211 can belong to the same process or two different processes.

Entities 210 and 211 communicate with each other by exchanging messages in a standard message format capable of being utilized by every entity 210-214 in each subsystem 220-224, respectively. The standard message format includes fields for carrying identification information for both the sending entity (e.g., entity 210) and the receiving entity (e.g., 211). The identification information for the sending entity 210 uniquely identifies the sending entity 210, and the identification information for the receiving entity 211 uniquely identifies the receiving entity 211.

For example, when entity 210 generates a message to entity 211, entity 210 includes identification information in the message that identifies the receiving entity 211. Upon receipt of the message, common interface handler 250 uses the identification information included within the message to uniquely identify receiving entity 211 and deliver the message to receiving entity 211. In one embodiment, common interface handler 250 stores tables containing identification information and associated entity identities. Common interface handler 250 uses the identification information received in the message to index on the correct entity identity within the tables. The tables can be stored in a tiered format, such that common interface handler 250 indexes on only those portions of the identification information that are necessary to determine the identity of the entity. Common interface handler 250 can further generate a key for the sending entity from the sending entity identification information in the message header and a key for the receiving entity from the receiving entity identification information in the message header and use these keys in all subsequent message exchanges between the sending entity and receiving entity.

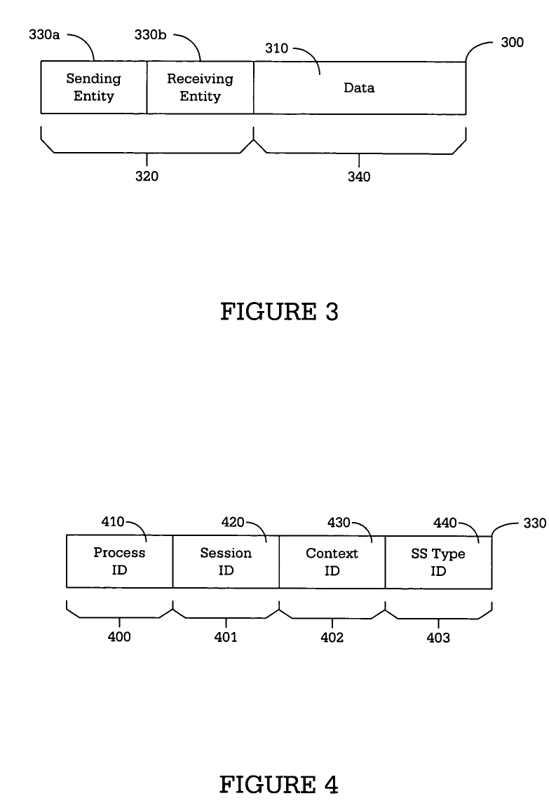

FIG. 3 illustrates a standard format for a message 300 according to an exemplary embodiment of the present invention. The message includes a header 320 and a body 340. Within the header 320 are sending entity identification information 330a and receiving entity identification information 330b. The sending entity identification information 330a identifies the sending entity. The receiving entity identification information 330b identifies the receiving entity. Within the body 340 is data 310 to be sent from the sending entity to the receiving entity.

FIG. 4 illustrates a standard format for identification information 330 within message 300, according to an exemplary embodiment of the present invention. Identification information 330 can be either the sending entity identification information 330 or the receiving entity identification information 330b in FIG. 3. Thus, sending entity identification information 330a and receiving entity identification information 330b in FIG. 3 each have the format of identification information 330 in FIG. 4.

Identification information 330 for either the sending entity or receiving entity is used by the common interface handler to uniquely identify the specific sending entity or receiving entity. Identification information 330 includes four data fields 400-403. Each data field 400-403 stores a portion of identification information 330.

Field 400 stores an interface handler identifier 410 identifying a common interface handler (250, shown in FIG. 2) running within processing node (200, shown in FIG. 2) that the entity belongs to. Field 401 stores a session identifier 420 identifying a session that the entity belongs to. As used herein and in the claims below, the term “session” refers to a particular call that is currently using the process identified by the process identifier. For example, the session can be a particular voice call or data call between a calling party and a called party. Field 402 stores a context identifier 430 identifying a context within the session that the entity belongs to. For example, the context can be a new incoming call to the calling party or called party during the existing call between the calling and called parties.

Field 403 stores a subsystem type identifier 440 identifying a standard subsystem type that the entity belongs to. Each subsystem (e.g., subsystem 220 in FIG. 2) within telecommunication node (200, shown in FIG. 2) has a standard subsystem type associated with it. As new subsystems are added to the telecommunication node, the common interface handler associates one of the standard subsystem types with the new subsystems to facilitate identification of the particular subsystems using the standard subsystem types. From the interface handler identifier 410, session identifier 420, context identifier 430 and subsystem type identifier 440, the identity of the entity (sending or receiving) can be ascertained.

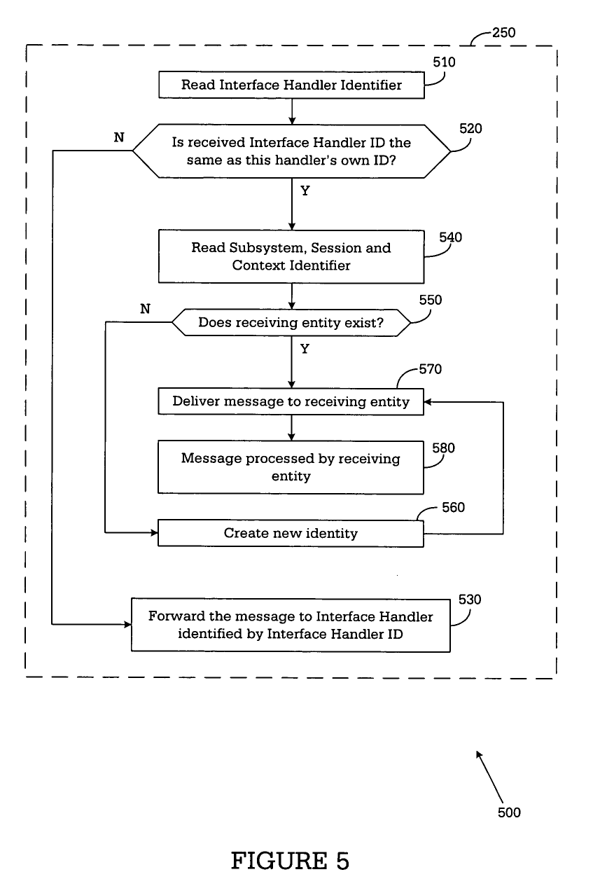

FIG. 5 depicts a flow diagram 500 illustrating the operation of the common interface handler 250 according to one embodiment of the present invention. Messages are sent between entities belonging to different subsystems through the common interface handler using a standard message format that uses identification information in the message header to uniquely identify the sending entity and receiving entity. The identification information in the message header includes an interface handler identifier, session identifier, context identifier and subsystem type identifier.

When the common interface handler receives a message from a sending entity destined for a receiving entity in the standard message format, the common interface handler reads the interface handler identifier in the message header (process step 510) to determine if the identity of the common interface handler matches the interface handler identifier (process step 520). If not, the common interface handler forwards the message to the common interface handler identified by the interface handler identifier (process step 530). If so, the common interface handler reads the session, context and subsystem type identifiers in the message header (process step 540).

If the receiving entity does not yet exist in the network node (process step 550), the common interface handler creates the receiving entity (process step 560) and delivers the message to the newly created receiving entity (process step 570), where the message is processed (process step 580). However, if the receiving entity does currently exist (process step 550), the common interface handler delivers the message to the receiving entity (process step 570), and the receiving entity processes the message (process step 580).

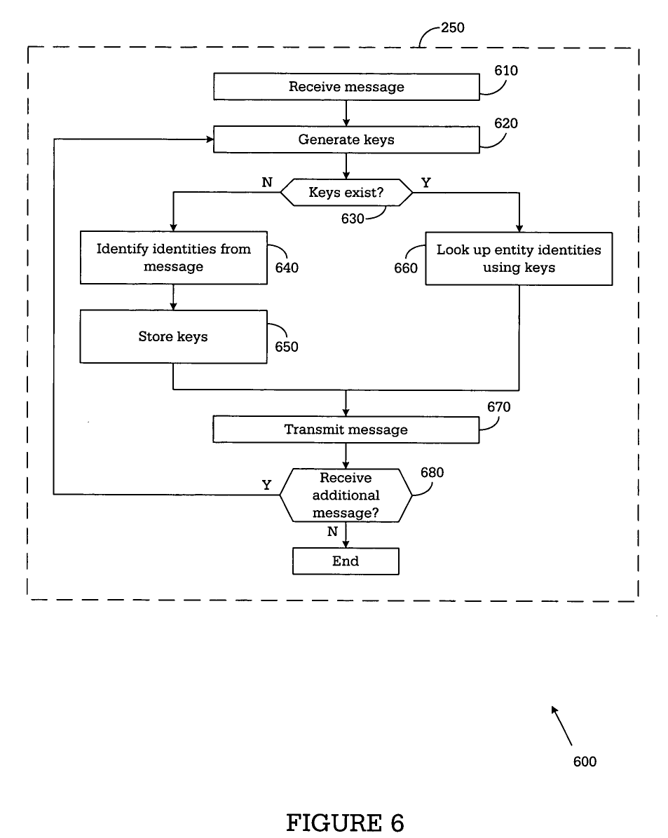

FIG. 6 is a flow diagram 600 illustrating the operation of the common interface handler 250 according to another embodiment of the present invention. When the common interface handler receives a message from a sending entity destined for a receiving entity (process step 610), the common interface handler generates a key for the sending entity from the sending entity identification information and a key for the receiving entity from the receiving entity identification information included in the message header (process step 620). The keys are unique codes generated from the sending entity identification information and receiving entity identification information. If one or both of the keys do not already exist (i.e., if previous messages between the sending entity and receiving entity have not been received) (process step 630), the common interface handler determines the identity of either or both of the sending entity and receiving entity from the identification information in the message header (process step 640) and stores the keys in an active session pool to associate the common interface handler session with the communication between the sending entity and receiving entity (process step 650). For example, the common interface handler can identify the sending and receiving entities using a process as described in FIG. 5.

However, if one or both of the keys already exist (process step 630), the common interface handler uses the key(s) to look-up the identities of either of both of the sending entity and receiving entity without requiring the common interface handler to repeat the entity identification process (process step 660). Once the receiving entity has been identified, the common interface handler delivers the message to the receiving entity (process step 670). If an additional message transmitted between the sending and receiving entities is received (process step 680), the common interface handler generates the keys (process step 620) and uses the keys to look-up the sending and receiving entity identities.

Although the present invention has been described with an exemplary embodiment, various changes and modifications may be suggested to one skilled in the art. It is intended that the present invention encompass such changes and modifications as fall within the scope of the appended claims.

1. For use in a telecommunications network, a network node comprising a plurality of subsystems, said network node comprising:
a sending entity associated with a first one of the plurality of subsystems, said sending entity being configured to generate a message including identification information in a standard format capable of being utilized by each of the plurality of subsystems;
a receiving entity associated with a second one of the plurality of subsystems, said receiving entity being configured to receive the message; and
a common interface handler in communication with said sending entity and said receiving entity, said common interface handler being operable to receive the message from said sending entity, identify said receiving entity from the identification information and transmit the message to said receiving entity.

2. The network node as set forth in claim 1 wherein the standard format of the identification information includes an interface identifier identifying said common interface handler.

3. The network node as set forth in claim 2 wherein the standard format of the identification information further includes a session identifier identifying a session associated with said receiving entity.

4. The network node as set forth in claim 3 wherein the standard format of the identification information further includes a context identifier identifying a leg of the session associated with said receiving entity.

5. The network node as set forth in claim 4 wherein the standard format of the identification information includes a subsystem type identifier identifying the second subsystem associated with said receiving entity.

6. The network node as set forth in claim 1 wherein said common interface handler is further operable to identify said sending entity from the identification information.

7. The network node as set forth in claim 1 wherein said common interface handler is further operable to create said second entity from the identification information.

8. The network node as set forth in claim 1 wherein said common interface handler is further operable to generate at least one key from the identification information, the key identifying at least one of said sending entity and said receiving entity.

9. The network node as set forth in claim 8 wherein said common interface handler is further operable to receive an additional message, generate the at least one key from the additional message and identify at least one of said sending entity and said receiving entity using the at least one key.

10. A telecommunications network comprising a plurality of network nodes, each of said plurality of network nodes including a plurality of subsystems, wherein said each network node comprises:
a sending entity associated with a first one of the plurality of subsystems, said sending entity being configured to generate a message including identification information in a standard format capable of being utilized by each of the plurality of subsystems;
a receiving entity associated with a second one of the plurality of subsystems, said receiving entity being configured to receive the message; and
a common interface handler in communication with said sending entity and said receiving entity, said common interface handler being operable to receive the message from said sending entity, identify said receiving entity from the identification information and transmit the message to said receiving entity.

11. The telecommunications network as set forth in claim 10 wherein the standard format of the identification information includes an interface handler identifier identifying said common interface handler.

12. The telecommunications network as set forth in claim 11 wherein the standard format of the identification information further includes a session identifier identifying a session associated with said receiving entity.

13. The telecommunications network as set forth in claim 12 wherein the standard format of the identification information further includes a context identifier identifying a leg of the session associated with said receiving entity.

14. The telecommunications network as set forth in claim 13 wherein the standard format of the identification information includes a subsystem type identifier identifying the second subsystem associated with said receiving entity.

15. The telecommunications network as set forth in claim 10 wherein said common interface handler is further operable to identify said sending entity from the identification information.

16. The telecommunications network as set forth in claim 10 wherein said common interface handler is further operable to create said second entity from the identification information.

17. The telecommunications network as set forth in claim 10 wherein said common interface handler is further operable to generate at least one key from the identification information, the at least one key identifying at least one of said sending entity and said receiving entity.

18. The telecommunications network as set forth in claim 17 wherein said common interface handler is further operable to receive an additional message, generate the at least one key from the additional message and identify at least one of said sending entity and said receiving entity using the at least one key.

19. For use in a telecommunications network, a method of handling communications between subsystems of a network node within the telecommunications network, the method comprising the step of:
receiving a message generated by a sending entity associated with a first one of the subsystems, the message including identification information identifying a receiving entity associated with a second one of the subsystems in a standard format capable of being utilized by each of the subsystems;
identifying the receiving entity for the message from the identification information; and
transmitting the message to the receiving entity.

20. The method as set forth in claim 19 wherein the standard format of the identification information includes an interface handler identifier identifying the common interface handler.

21. The method as set forth in claim 20 wherein the standard format of the identification information further includes a session identifier identifying a session associated with the receiving entity, and wherein said identifying further includes identifying the receiving entity using the interface handler identifier and the session identifier.

22. The method as set forth in claim 21 wherein the standard format of the identification information further includes a context identifier identifying a leg of the session associated with the receiving entity, and wherein said identifying further includes identifying the receiving entity using the interface handler identifier, the session identifier and the context identifier.

23. The method as set forth in claim 22 wherein the standard format of the identification information includes a subsystem type identifier identifying the second subsystem associated with said receiving entity, and wherein said identifying further includes identifying said receiving entity using the interface handler identifier, the session identifier, the context identifier and the subsystem type identifier.

24. The method as set forth in claim 19 further comprising:
identifying the sending entity from the identification information.

25. The method as set forth in claim 19 further comprising:
creating the second entity from the identification information.

26. The method as set forth in claim 19 further comprising:
generating at least one key from the identification information, the at least one key identifying at least one of the sending entity and the receiving entity.

27. The method as set forth in claim 26 further comprising:
receiving an additional message;
generating the at least one key from the additional message; and
identifying at least one of the sending entity and the receiving entity using the at least one key.
